(19) United States
(12) Patent Application Publication
(10) Pub. No.: US 2026/0338362 A1
(43) Pub. Date: Oct. 29, 2026

(54) DEVICES, SYSTEMS, AND METHOD FOR MOUNTING LIGHTING FIXTURES AND POWER ENCLOSURE ASSEMBLY FOR LIGHTING SYSTEMS

(71) Applicant: footcandle LLC, Denver, CO (US)

(72) Inventors: Brian Stern, Denver, CO (US); Kale Lacroux, Carbondale, CO (US); Justin Streeb, Carbondale, CO (US); Calvin Lanpher, Boulder, CO (US)

(73) Assignee: footcandle LLC, Denver, CO (US)

(21) Appl. No.: 19/656,709

(22) Filed: Apr. 23, 2026

Related U.S. Application Data
(60) Provisional application No. 63/793,461, filed on Apr. 23, 2025.

(51) Int. Cl. F21V 21/35

(52) U.S. Cl. CPC F21V 21/35

(57) ABSTRACT

A securing member includes a base and first and second sidewalls. The base of the securing member includes a lighting channel defined by a lower surface and two projections of the base. The lighting channel is configured to receive a lighting fixture. The securing member further includes a slot, which is defined by the first and second sidewalls of the securing member and an upper surface of the base. The slot is configured to receive a rail and secure the securing member to the rail. A lighting mounting system includes the rail, the securing member, and one or more exterior panels. The lighting mounting system has a power supply and is configured to operate in a Class 2 low-voltage environment.

### CROSS REFERENCE

This U.S. Non-Provisional Patent Application claims benefit of U.S. Provisional Application No. 63/793,461, filed on Apr. 23, 2025, the entire disclosure of which is hereby incorporated by reference.

### FIELD

The present disclosure is directed to systems and methods for lighting installation and, in particular, to systems and methods with securing members compatible with conventional lighting rails and construction elements, e.g., structural grid systems, steel decking, structural members, etc., to receive lighting strips and operate under a low voltage environment. The present disclosure is further directed to enclosures and mounting mechanisms for power enclosures for lighting systems.

### BACKGROUND

The background description includes information that may be useful in understanding the present inventive subject matter. It is not an admission that any of the information provided herein is prior art or relevant to the presently claimed disclosure, or that any publication specifically or implicitly referenced is prior art.

Traditional lighting systems for large facilities, for example, data centers, are limited to line voltage strip fixtures. Installing such fixtures requires numerous components, such as conduit and j-boxes, and generally involves many complicated installation steps, including cutting and bending conduit, installing conduit, installing j-boxes, and making connections between the components. Existing systems generally require that certified electricians spend numerous hours completing the installation of each fixture.

Furthermore, conventional line voltage strip lighting systems operate at a high voltage environment, which requires certified electricians to conduct the installation work, resulting in increased labor and other costs.

Accordingly, there exists a long-felt but unmet need to provide an efficient and economical solution for lighting installation. In particular, there is a long-felt but unmet need for a lighting installation system that is efficient to install and safe to operate.

### SUMMARY

In various embodiments and as shown and described herein, systems and devices are provided that are operable to communicate with and be secured to conventional, existing hardware such as a c-beam, track lighting member, strut channel, framing strut, structural grid systems, steel decking, structural members, etc.

Embodiments of the present disclosure are directed to securing members used for mounting lighting fixtures. In some embodiments, a securing member includes a body, wherein the body has a base, a first channel extending along a lateral axis, and one or more lighting channels extending along the longitudinal axis. The first channel has an opening configured to receive a rail and secure the securing member to the rail, and each of the one or more lighting channels is configured to receive a lighting fixture and secure the lighting fixture to the securing member. The opening of the first channel faces a different direction to the openings of the one or more lighting channels. For example, the opening of the first channel may be 180 degrees apart from the openings of the one or more lighting channels.

In some embodiments, a securing member is provided that comprises a first sidewall and a second sidewall. The base of the securing member has an upper surface and a lower surface. The first and second sidewalls project from the upper surface of the base. Together, the first and second sidewalls and the upper surface of the base define the first channel.

In some embodiments, a base of the securing member has two or more projections extending from the lower surface vertically in a direction opposite to the first and second sidewalls. The two or more projections and the lower surface of the base define the one or more lighting channels.

Some embodiments of the present disclosure are directed to lighting mounting systems. The lighting mounting system includes one or more securing members as discussed above, a rail, one or more exterior panels, and optionally, one or more fasteners, and a power supply. In some other embodiments, the lighting mounting system is capable of receiving non-lighting fixtures. As will be explained below, additional embodiments according to the present disclosure are directed to an enclosure with mounting components that facilitate installation by a single user. In such embodiments, the enclosure is used to house a power supply unit, backup battery unit and/or a controller unit.

In some embodiments, each of the one or more securing members includes exterior surfaces of the first and second sidewalls. The exterior surfaces of the securing member may have one or more slots configured to receive the one or more exterior panels. The exterior panels are configured to protect the body, for example, from water damage and chemical erosion. The exterior panels also create a smooth finish to the securing member and the lighting system.

In some embodiments, the exterior panels are constructed of magnetic materials. The magnetic panels can be attached to the exterior surfaces of the securing members quickly and easily without any additional tools or fasteners.

In some embodiments, the rail has a plurality of apertures placed on a base of the rail along a lateral axis. Each of the plurality of apertures is configured to receive a fastener, for example, a threaded bolt. The base of the body may also have an aperture. When in operation, the aperture of the base of the body is aligned to the aperture of the rail, and the fastener passes through both apertures to secure the securing member and prevent movements of the securing member relative to the rail.

In some embodiments, the lighting mounting system is operated under a Class 2 low voltage environment. The low-voltage operating environment provides safe working conditions for electricians and installers. No certified electrician is required to complete the lighting installation through the systems in the present disclosure, which significantly reduces the labor costs of the lighting installation.

In some embodiments, the lighting mounting system is provided with a power supply. The power supply may include an electrical wire with one or more ports. Each of the one or more ports is constructed to receive a lighting fixture, for example, an LED strip. In some embodiments, the securing member is provided as a clip with a width that can be widened to receive a rail and/or a lighting fixture.

In some embodiments of the present disclosure, the lighting mounting system is provided as a temporary lighting solution. In some other embodiments, the lighting mounting system may be installed as a permanent lighting fixture. In yet another embodiment, the lighting mounting system is initially installed to meet temporary lighting needs and later converted to a permanent lighting fixture without removing any of the existing components.

In embodiments, the lighting mounting system comprises a control system having a sensor, a control center, and/or a low-voltage data module. In some embodiments, the control system is planted in a chip. In some embodiments, the chip may be installed in the rail of the lighting mounting system. It is appreciated that the installation and configuration of the control system may vary in different embodiments.

In embodiments, the lighting mounting system is constructed to be used in various environments. For example, some embodiments of the present disclosure are constructed with waterproof exterior panels so that the system may be used in an outdoor, high-humidity environment. Some embodiments of the present disclosure are constructed to be used for cleanroom applications, for example, IP/NEMA-rated environments. In yet some other embodiments, the lighting mounting system may be constructed with fire-rated, chemical-resistant materials to ensure the system and the connected lighting fixtures are functional in extreme conditions.

In embodiments, the lighting mounting systems are constructed to comply with the NEC Class 2 low-voltage compliance to limit power potential to under 100 volt-amperes. For example, the circuits of the system are designed to prevent shock and fire hazards. It is appreciated that the designated power limit and circuit design varies in different embodiments.

To further support the written description requirement, examples of securing members, lighting mounting systems, and lighting fixtures for the like may be found in U.S. Patent. Application No. 63/729,058, of which is incorporated herein in its entirety.

Additional embodiments according to the present disclosure are directed to a power enclosure assembly for a lighting system that may be installed onto or connected to a building component by a single user. While various embodiments disclosed herein are directed to a power enclosure assembly, the present disclosure contemplates that an enclosure assembly as described may be used to house power components of other electrical systems, other than a lighting system, and/or to house components other than power and/or electrical components of other systems.

The power enclosure assembly comprises a mounting assembly with one or more mounting brackets on an enclosure. In various embodiments, the enclosure comprises a plurality of panels that collectively define a closed shape. In one or more embodiments, the enclosure comprises a group of side panels that define a quadrilateral shape. In various embodiments, a base panel and/or cover panel is connected to each of the side panels to define the enclosure. In various embodiments, the mounting assembly comprises one or more mounting brackets on top or cover panel such that the power enclosure assembly can be secured in a suspended arrangement, i.e., supported from the top. In other embodiments, the mounting assembly comprises with one or more brackets on the base or bottom panel such that the power enclosure assembly can be secured in an upright arrangement, i.e., supported form the bottom.

In one or more embodiments of the power enclosure assembly according to the present disclosure, the mounting brackets are attachable directly to a connecting member and/or to a mounting cover that is attachable to a connecting member. In various embodiments, a mounting bracket at least one side portion adjacent to a base and a top portion. The base is generally connected to the base panel or the cover panel of the enclosure, but it may also be connected to another mounting bracket that is already installed on the base panel and/or cover panel. In various embodiments, the side portion and the top portion collectively define a cavity for insertion of a connecting portion of a mounting cover and/or a connecting member. In one or more embodiments, the mounting bracket comprises two side portions oppositely disposed to one another on the sides of a common base.

In various embodiments, the mounting bracket extends along an axis that is substantially transverse to a longitudinal axis of the enclosure. In other embodiments, the mounting bracket extends along the longitudinal axis. In alternative embodiments, the mounting bracket is on a plane that is coincident with the base panel and/or the cover panel, and is inclined relative to the longitudinal axis and/or the transverse axis.

In some embodiments, the power enclosure assembly comprises a “stacked arrangement” of mounting brackets. In such embodiments, a first mounting bracket is connected to the base panel and/or the cover panel, and a second bracket is connected to the first mounting bracket, including transverse to one another. In various embodiments, the second bracket is aligned along the longitudinal axis. In various embodiments, the mounting assembly comprises two (or more) pairs of mounting brackets are provided, including with outer mounting brackets being aligned with one another along the longitudinal axis. In other embodiments, the outer mounting brackets are transverse to the longitudinal axis. Accordingly, the mounting brackets may be slidably engageable with a connecting member and/or a mounting cover that is associated with or connected to a connecting member. In various embodiments, the mounting brackets are spaced apart from one another an offset distance.

In one or more embodiments, the power enclosure assembly comprises various mounting components that may be slidably connected to one another to facilitate installation of the power enclosure assembly. In various embodiments, the mounting brackets are configured and dimensioned for a slidable insertion of a connecting portion(s) of a mounting cover and/or a connecting member. As contemplated by various embodiments, a user may manually slide a mounting bracket into a connecting member, e.g., a strut, that is already attached or connected to a building structure or component. In at least one embodiment, the user may manually slide the mounting bracket(s) into a connecting member that is surface mounted, for example, to a wall or a ceiling. After an initial engagement, the user may further slide the mounting bracket within the connecting member into an intended position where the mounting bracket may be secured.

In one or more embodiments, a securing member and a mounting cover are used to retain a connecting member that is already installed or associated with a building component or structure. In various embodiments, a securing member is placed around the connecting member and a mounting cover is placed adjacent to the connecting member. As such, the base portions of the securing member are adjacent to the mounting cover such that a fastener or connector may be used to secure the securing member to the mounting cover thereby retaining the connecting member within the securing member and the mounting cover. Once the connecting member is secured, the bracket(s) may be inserted into the mounting cover to initially retain the power enclosure assembly. Thereafter, position of the brackets may be adjusted within the mounting covers such that the power enclosure assembly is at an intended position where it may be secured.

Additional embodiments according to the present disclosure are directed to a method for installing a power enclosure assembly onto a building structure. In one or more embodiments, the method initially comprises providing a power enclosure assembly for a lighting system as described herein. In various embodiments, the method further comprises inserting the mounting bracket(s) onto a connecting member directly, or to a mounting cover associated with a connecting member. In various embodiments, the method further comprises positioning the mounting bracket(s) such that the enclosure is at an intended position within the connecting member or the mounting cover. In one or more embodiments, the method further comprises securing the mounting bracket(s) to the connecting member and/or the mounting cover.

One or more embodiments according to the present disclosure are directed to a power enclosure assembly for a lighting system, with the power enclosure assembly comprising: 1) an enclosure operable to enclose at least one of a power supply unit, a battery unit and a control module; the enclosure comprising a plurality of panels collectively defining a closed shape of the enclosure; the plurality of panels comprising a group of side panels, a base panel and a cover panel; and 2) a mounting assembly comprising a mounting bracket(s) on the cover panel or on the base panel. In one or more embodiments, the mounting bracket(s) is attachable by a single user to a connecting member associated with a building structure.

In one or more embodiments of the power enclosure assembly, the group of side panels comprises at least one side panel extending along a longitudinal axis defined along a length of the at least one side panel.

In one or more embodiments of the power enclosure assembly, the group of side panels comprises four side panels collectively defining a quadrilateral shape of the enclosure.

In one or more embodiments of the power enclosure assembly, the mounting bracket(s) extends along a transverse axis defined along a length of the mounting bracket(s).

In one or more embodiments of the power enclosure assembly, the transverse axis is substantially perpendicular to the longitudinal axis.

In one or more embodiments of the power enclosure assembly, the mounting bracket(s) comprises a first mounting bracket and a second mounting bracket on the cover panel or on the base panel.

In one or more embodiments of the power enclosure assembly, the first mounting bracket and the second mounting bracket are disposed in spaced apart relation to one another along the longitudinal axis.

In one or more embodiments of the power enclosure assembly, the first mounting bracket and the second mounting bracket extend respectively along a first transverse axis and a second transverse axis, and wherein the first transverse axis and the second transverse axis are substantially parallel to one another and are substantially perpendicular to the longitudinal axis.

In one or more embodiments of the power enclosure assembly, the mounting bracket(s) extends along the longitudinal axis.

In one or more embodiments of the power enclosure assembly, the mounting bracket(s) comprises a first mounting bracket on the cover panel or on the base panel extending along a transverse axis that is substantially perpendicular to the longitudinal axis.

In one or more embodiments of the power enclosure assembly, the mounting bracket(s) comprises a second mounting bracket connected to the first mounting bracket and extending along the longitudinal axis.

In one or more embodiments of the power enclosure assembly, the second mounting bracket is attachable by the single user to the connecting member associated with the building structure.

In one or more embodiments of the power enclosure assembly, the mounting bracket(s) comprises: a base attachable to the cover panel or the base panel; at least one side portion adjacent to the base; and at least one top portion adjacent to the at least one side portion.

In one or more embodiments of the power enclosure assembly, the at least one side portion and the at least one top portion collectively define a cavity operable to retain a portion of the connecting member or a portion of the mounting cover operable to retain the connecting member.

In one or more embodiments of the power enclosure assembly, the mounting bracket and the connecting member are slidably attachable to one another, or wherein the mounting bracket and the mounting cover are slidably attachable to one another.

In one or more embodiments, the power enclosure assembly further comprises: a mounting cover disposable onto the at least one mounting bracket; a securing member connectable to the mounting cover; and the mounting cover and the connecting member cooperating with one another to secure the connecting member.

In one or more embodiments of the power enclosure assembly, the securing member comprises at least one base portion adjacent to at least one side portion, and wherein the side portion is adjacent to a top portion.

In one or more embodiments of the power enclosure assembly, the side portion is engageable to the mounting cover, and wherein the mounting cover, at least one side portion and the top portion at least partially enclose a portion of the connecting member.

In one or more embodiments of the power enclosure assembly, the mounting cover is slidable onto the at least one mounting bracket.

In one or more embodiments of the power enclosure assembly, the power supply unit or the battery unit is operable to power a plurality of light fixture channels at to achieve at least one footcandle of illumination.

Additional embodiments according to the present disclosure are directed to a method for installing a power enclosure assembly onto a building structure, with the method comprising: 1) providing a power enclosure assembly for a lighting system, the power enclosure assembly comprising: an enclosure operable to enclose at least one of a power supply unit, a battery unit and a control module; the enclosure comprising a plurality of panels collectively defining a closed shape of the enclosure; the plurality of panels comprising a group of side panels, a base panel and a cover panel; and a mounting assembly comprising at least one mounting bracket on the cover panel or on the base panel; and the at least one mounting bracket slidably attachable by a single user to a connecting member associated with the building structure; 2) inserting the at least one mounting bracket onto a connecting member or a mounting cover attached to the connecting member to achieve a suspension of the enclosure; 3) positioning the at least one mounting bracket such that the enclosure is at an intended position within the connecting member or the mounting cover; and 4) securing the at least one mounting bracket to the connecting member or the mounting cover.

The phrases “at least one”, “one or more”, and “and/or”, as used herein, are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

Unless otherwise indicated, all numbers expressing quantities, dimensions, conditions, and so forth used in the specification and claims are to be understood as being modified in all instances by the term “about” or “approximately”. As used herein, unless otherwise specified, the terms “about,” “approximately,” etc., when used in relation to numerical limitations or ranges, mean that the recited limitation or range may vary by up to 10%. By way of non-limiting example, “about 750” can mean as little as 675 or as much as 825, or any value therebetween. When used in relation to ratios or relationships between two or more numerical limitations or ranges, the terms “about,” “approximately,” etc. mean that each of the limitations or ranges may vary by up to 10%; by way of non-limiting example, a statement that two quantities are “approximately equal” can mean that a ratio between the two quantities is as little as 0.9:1.1 or as much as 1.1:0.9 (or any value therebetween), and a statement that a four-way ratio is “about 5:3:1:1” can mean that the first number in the ratio can be any value of at least 4.5 and no more than 5.5, the second number in the ratio can be any value of at least 2.7 and no more than 3.3, and so on.

The use of “substantially” in the present disclosure, when referring to a measurable quantity (e.g., a diameter or other distance) and used for purposes of comparison, is intended to mean within 5% of the comparative quantity. The terms “substantially similar to,” “substantially the same as,” and “substantially equal to,” as used herein, should be interpreted as if explicitly reciting and encompassing the special case in which the items of comparison are “similar to,” “the same as” and “equal to,” respectively.

The term “a” or “an” entity, as used herein, refers to one or more of that entity. As such, the terms “a” (or “an”), “one or more” and “at least one” can be used interchangeably herein.

The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein. The use of “engaged with” and variations thereof herein is meant to encompass any direct or indirect connections between components.

It shall be understood that the term “means” as used herein shall be given its broadest possible interpretation in accordance with 35 U.S.C. § 112(f). Accordingly, a claim incorporating the term “means” shall cover all structures, materials, or acts set forth herein, and all of the equivalents thereof. Further, the structures, materials, or acts and the equivalents thereof shall include all those described in the Summary, Brief Description of the Drawings, Detailed Description, Abstract, and claims themselves.

These and other advantages will be apparent from the disclosure of the invention(s) contained herein. The above-described embodiments, objectives, and configurations are neither complete nor exhaustive. The Summary is neither intended nor should it be construed as being representative of the full extent and scope of the present disclosure. Moreover, references made herein to “the present disclosure” or aspects thereof should be understood to mean certain embodiments of the present disclosure and should not necessarily be construed as limiting all embodiments to a particular description. The present disclosure is set forth in various levels of detail in the Summary as well as in the attached drawings and the Detailed Description and no limitation as to the scope of the present disclosure is intended by either the inclusion or non-inclusion of elements, components, etc. in this Summary. Additional aspects of the present disclosure will become more readily apparent from the Detailed Description, particularly when taken together with the drawings.

It is to be appreciated that any feature or aspect described herein can be claimed in combination with any other feature(s) or aspect(s) as described herein, regardless of whether the features or aspects come from the same described embodiment.

Any one or more aspects described herein can be combined with any other one or more aspects described herein. Any one or more features described herein can be combined with any other one or more features described herein. Any one or more embodiments described herein can be combined with any other one or more embodiments described herein.

### BRIEF DESCRIPTION OF THE DRAWINGS

Those of skill in the art will recognize that the following description is merely illustrative of the principles of the disclosure, which may be applied in various ways to provide many different alternative embodiments. This description is made for illustrating the general principles of the teachings of this disclosure and is not meant to limit the inventive concepts disclosed herein.

The accompanying drawings, which are incorporated in and constitute a part of the specification, illustrate embodiments of the disclosure and together with the general description of the disclosure given above and the detailed description of the drawings given below, serve to explain the principles of the disclosure.

FIG. 1 is a perspective view of a securing member attached to a rail, in accordance with one or more embodiments of the present disclosure;

FIG. 2A is a perspective view of a lighting mounting system, in accordance with one or more embodiments of the present disclosure;

FIG. 2B is a bottom perspective view of the lighting mounting system of FIG. 2A;

FIG. 2C illustrates a securing member attached to a rail of the lighting mounting system of FIG. 2A;

FIG. 2D illustrates the lighting fixture mounting system of FIG. 2A with an input power;

FIG. 2E illustrates lighting fixture mounting system with a lighting fixture attached to the securing member of FIG. 2A;

FIG. 3 is a process flow diagram for a method of mounting lighting fixtures; in accordance with one or more embodiments of the present disclosure;

FIG. 4 is a process flow diagram for another method of mounting lighting fixtures, in accordance with one or more embodiments of the present disclosure.

FIG. 5 is a perspective view of a power enclosure assembly according to one or more embodiments according to the present disclosure.

FIG. 6 is another perspective view of a power enclosure assembly according to one or more embodiments according to the present disclosure.

FIG. 7 is a bottom perspective view of a power enclosure assembly according to one or more embodiments according to the present disclosure.

FIG. 8 is a further perspective view of a power enclosure assembly according to one or more embodiments according to the present disclosure.

FIG. 9 is an even further perspective view of a power enclosure assembly according to one or more embodiments according to the present disclosure.

FIG. 10 is yet another perspective view of a power enclosure assembly according to one or more embodiments according to the present disclosure.

It should be understood that the drawings are not necessarily to scale, and various dimensions may be altered. In certain instances, details that are not necessary for an understanding of the disclosure or that render other details difficult to perceive may have been omitted. It should be understood, of course, that the disclosure is not necessarily limited to the particular embodiments illustrated herein. It is noted that any line in the drawings may be illustrated as solid or broken lines, including any section or length of each individual line, without departing from the scope of the present disclosure. It will be appreciated that recitation of, for example, reference character 116, 116A, 116B, etc. may apply to any combination of reference characters 116, 116A, 116B, etc.

### DETAILED DESCRIPTION

Although the following text sets forth a detailed description of numerous different embodiments, it should be understood that the legal scope of the description is defined by the words of the claims set forth at the end of this disclosure. The Detailed Description is to be construed as exemplary only and does not describe every possible embodiment of the devices, systems, and methods for mounting lighting fixtures since describing every possible embodiment would be impractical, if not impossible. Numerous alternative embodiments could be implemented using either current technology or technology developed after the filing date of this patent, which would still fall within the scope of the claims. Additionally, any combination of features shown in the various figures can be used to create additional embodiments of the present disclosure. Thus, dimensions, aspects, and features of one embodiment of the devices, systems, and methods for mounting lighting fixtures can be combined with dimensions, aspects, and features of another embodiment of the devices, systems, and methods for mounting lighting fixtures to create the claimed embodiment.

Embodiments of the present disclosure are directed to securing members used to mount lighting systems, specifically for mounting lighting systems to various building components as described herein, including without limitation, surfaces, metal decking, structural grid systems, etc.

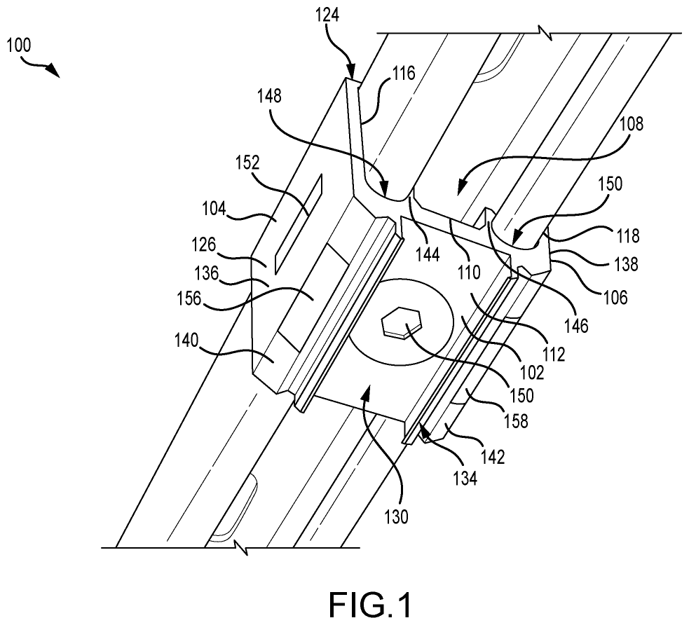

FIG. 1 illustrates a securing member 100 in a mounted state and being attached to a rail, in accordance with one or more embodiments of the present disclosure. The securing member 100 includes a base 102, a first sidewall 104 and a second sidewall 106, and a recess 108. The first and second sidewalls 104 and 106 extend from an upper surface 110 of the base 102 along a vertical dimension and are parallel to each other along a longitudinal dimension. Each of the first and second sidewalls 104 and 106 has an interior surface 116 and 118, respectively Each of the first and second sidewalls 104 and 106 has an exterior surface 126 and 128, respectively. The upper surface 110 of the base has a width extending longitudinally between the interior surfaces 116 and 118 of the first and second sidewalls 104 and 106. The base 102 further comprises a lower surface 112 extending longitudinally between the exterior surfaces 126 and 128 of the first and second sidewalls 104 and 106.

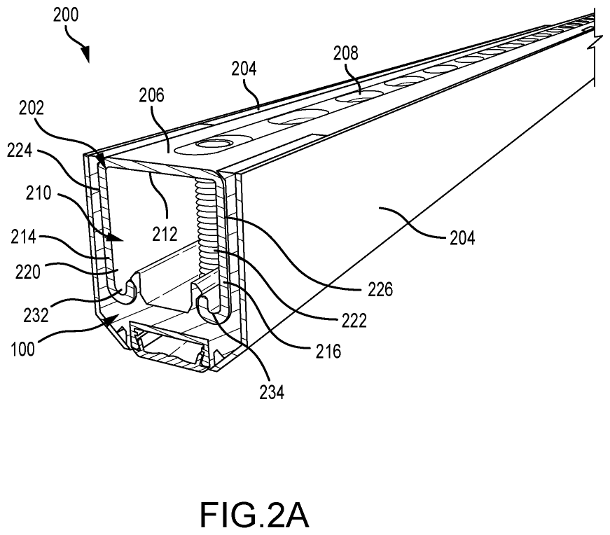

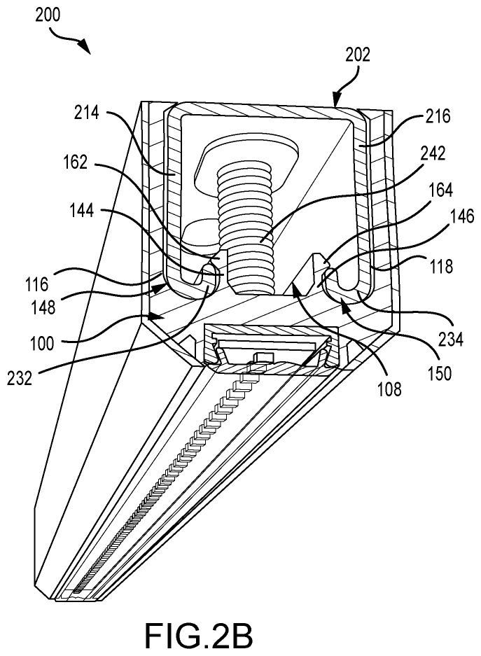

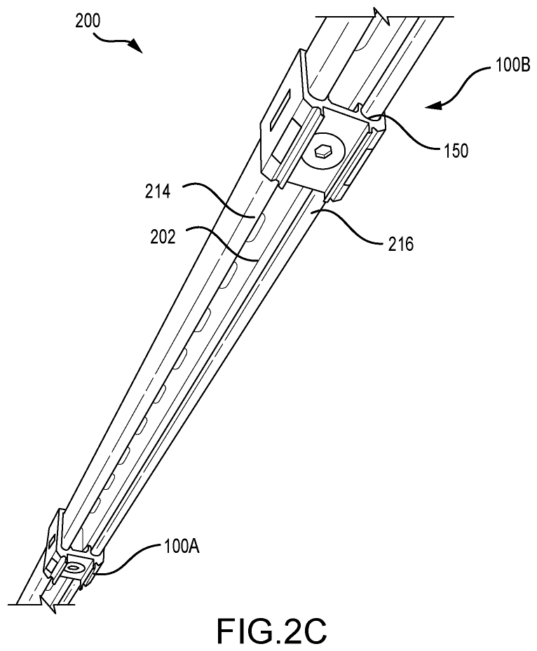

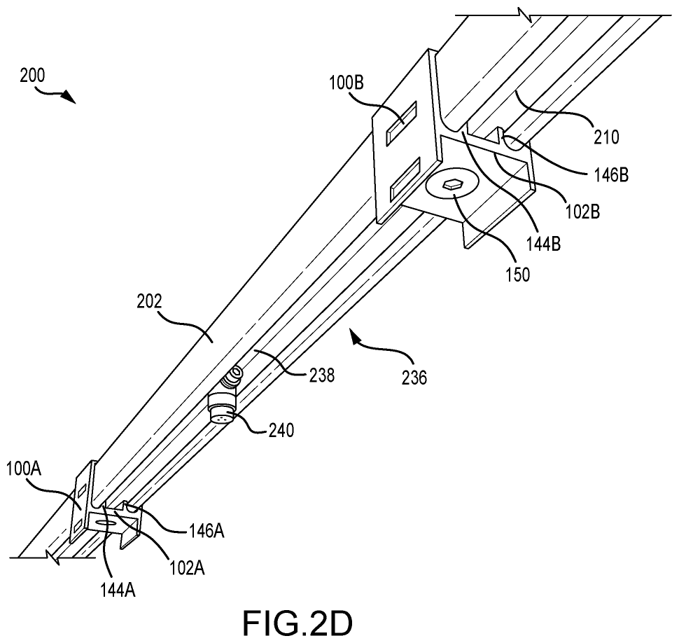

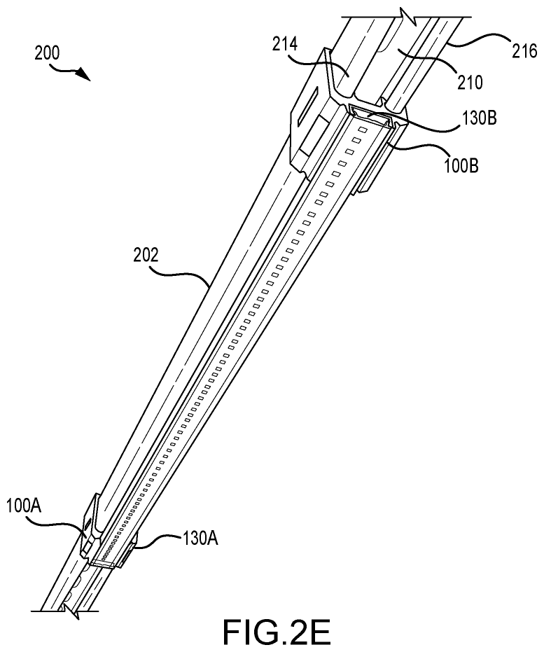

The upper surface 110 of the base and the interior surfaces 116 and 118 of the first and second sidewalls 104 and 106 collectively define the recess 108. The recess 108 has an opening 114 facing toward a top portion 124 of the securing member 100. In various embodiments, the recess 108 is configured to receive one or more rails 202 (as shown in FIGS. 2A-2E) and to secure the securing member 100 to the one or more rails 202. In some embodiments, one or more wires are inserted within the recess 108. In other embodiments, one or more wires are be placed between a sidewall of the rail 202 and the recess 108. In some embodiments, an optional cover is between the recess 108 and the rail 202, for example, to secure and cover a jumper or a port 240.

In various embodiments, the lower surface 112 of the base 102 has one or more slots 130 configured to receive one or more lighting fixtures. For example, a lighting fixture may include a lens or transparent cover, a lighting strip fitted within a bar component, and a lead wire to be connected to the power supply and/or the port 240. In various embodiments, the lower surface 112 has two projections 132 extending from the lower surface 112 of the base along a vertical direction. In one or more embodiments, the projections 132 are approximately perpendicular to the lower surface 112. In various embodiments, two projections 128 extend from the surface 112 and are parallel to each other in a longitudinal direction. The lower surface 112 of the base 102 and the two projections 132 collectively define a slot 130. In various embodiments, the slot 130 comprises an opening 134. However, the number and orientation of the one or more projections 132 may vary in different embodiments. Consequently, the number of slots 130 and the orientation of the slot opening 134 may also vary in different embodiments. Appendix A provides exemplary embodiments with different slot configurations. In various embodiments, the slot 130 is constructed and/or dimensioned to receive various lighting fixtures, including stripe-shaped lighting fixtures, such as LED strips. Also, the shape of the receivable lighting fixture may vary in different embodiments, depending on the structure of the securing member.

In various embodiments, each of the first and second sidewalls 104 and 106 comprises a first section 136 and 138 and a second section 140 and 142. In various embodiments, each of the first and second sidewalls 104 and 106 also comprises a nose 144 and 146, respectively, which extends from the upper surface 110. The second section 140 of the first sidewall 104 extends between the first section 136 and the nose 144. In various embodiments, the nose 144 is between the second section 140 of the first sidewall 104 and the upper surface 110 of the base 102. Together, the nose 144, the second section 140, and the first section 136 collectively define a first rail channel 148 within the recess 108 configured to receive at least a portion of a rail 202. Similarly, the second section 142 of the second sidewall 106 is between the first section 138 and the nose 146. In various embodiments, the nose 146 is between the second section 142 of the second sidewall 106 and the upper surface 110 of the base 102. In one or more embodiments, the nose 144, the second section 140, and the first section 136 define a second rail channel 150 within the recess 108 configured to receive another portion of a lighting rail 202. In various embodiments, the second sections 140 and 142 are constructed into a curved shape contour to the shape of commonly used rails, for example, a Unistrut channel rail or a C-channel rail. However, the shape of the second sections 140 and/or 142 of the sidewalls 104 and/or 106 may vary in other embodiments. It is also noted that the nose 144 and/or 146 is an optional feature. It is further appreciated that the shape and configuration of the sidewalls 104 and/or 106 of the securing member may vary in other embodiments.

As shown in FIG. 1, in one or more embodiments the first sidewall 104 has a cavity 152 located around and approximate center of the first section 136 of the first sidewall 104. The first sidewall 104 further has a cavity 156 located on the second section 140. The cavities 152 and 156 are configured to receive a finishing or exterior panel to provide a different surface post installation, including a polished surface. Similarly, the second sidewall 106 also has a cavity 154 located on the first section 138 and a cavity 158 located on the second section 142. In various embodiments, the sidewall cavities 152 and/or 156 comprise an approximately rectangular shape. It is appreciated that the shape and number of the sidewall cavities 152 and/or 156 may vary in different embodiments.

In various non-limiting embodiments, the base 102 includes an aperture 150 extending along a vertical axis from the lower surface 112 to the upper surface 110 into the recess 108. The aperture 150 is constructed to receive a fastener to further secure the securing member to the lighting rail and prevent the securing member from moving laterally along a length of the rail. However, in some embodiments, other apertures are provided on the base 102 and are dedicated for power conduits or lines to pass through from one side of the base 102 to the other.

FIG. 2A provides a perspective view of a lighting mounting system 200 in accordance with one or more embodiments of the present disclosure. Specifically, the lighting mounting system 200 includes a securing member 100, a rail 202, and one or more exterior panels 204. In the non-limiting embodiment, the rail 202 is pre-installed to a building, for example, a ceiling of a data center. However, in other embodiments, the rail 202 is pre-installed onto another component, including without limitation, a component of an HVAC system such as ducting and/or supporting brackets, a truss ceiling, a drop down ceiling, or more generally to a structure outside of a building, for example, the underside of a bridge, the exterior façade of a building, etc. However, various embodiments according to the present disclosure contemplate attaching the mounting system 200 and/or securing member 100 to a component other than a unit-strut or rail 202 as described herein. In one or more embodiments, the lighting mounting system 200 and/or securing member 100 is attachable directly to a component of an HVAC duct system, a component of a truss ceiling or bridge, a component of a drop down ceiling, etc. The rail 202 has a top 206, a slot 210 with a slot base 212, a plurality of apertures 208 extending from the top 206 to the slot base 212. The rail 202 further has a first sidewall 214 and a second sidewall 216 extending from the top 206 along a vertical dimension. The first and second sidewalls 214 and 216 each include an interior surface 220 and 222 and an exterior surface 224 and 226, respectively. The interior surfaces 220 and 222 and the slot base 206 define the slot 210. Each of the first and second sidewalls 214 and 216 of the rail 202 further includes a u-shaped lower portion 232 and 234, respectively.

As shown in FIGS. 2A-2B, when assembled, the rail 202 is received within the recess 108 of the securing member 100. Specifically, the first sidewall 214 of the rail is insertable into the first rail channel 148 of the securing member 100, where the exterior surface 224 (as shown in FIG. 2A) of the rail 202 is in contact with the interior surface 116 of the first sidewalls 104 of the securing member 100. Similarly, the second sidewall 216 of the rail 202 is inserted into the second rail channel 150 of the securing member 100, and the exterior surface 226 (as shown in FIG. 2A) of the second sidewall 216 of the rail 202 is in contact with the interior surface 118 of the second sidewall 106 of the securing member 100. In the non-limiting embodiment, each of the noses 144 and/or 146 of the first and second sidewalls 104 and 106 of the securing member 100 comprise a protrusion 162 and 164, respectively, extending towards the first sections 136 and 138 of the first and second sidewalls 104 and 106 of the securing member 100. The protrusions 162 and/or 164 extend a height from the bottom of the noses 144 and 146 that is at least equal to or greater than a maximum height of the lower portions 232 and 234 of the first and second sidewalls 104 and 106 of the rail 202. When the securing member 100 is assembled to the rail 202, the protrusions 162 and 164 extend over the top of the lower portions 232 and 234 and secure the securing member 100 to the rail 202.

In embodiments, the lighting mounting system 200 further includes one or more exterior panels 204. The one or more exterior panels 204 are attached to the exterior surfaces 126 and 128 (as shown in FIG. 1) of the first and second sidewalls 104 and 106 of the securing member 100. The exterior panels 204 are constructed with waterproof materials such as plastic or metal. The exterior panels 204 provide a polished exterior look to the lighting mounting system and prevent the securing members and rails from damage and erosion caused by the surrounding environments. The exterior panels are optional to the lighting mounting system, and the number of exterior panels applied to a lighting mounting system varies in different embodiments.

In some embodiments, the exterior panels 204 are constructed to be attached to the exterior surfaces 126 and 128 without a tool. For example, in some embodiments the exterior panels 204 comprise magnetic materials, which are capable of attaching to the exterior surfaces 126 and 128 without a fastener. In some other embodiments, the exterior panels 204 have one or more projections configured and/or dimensioned to define a mating engagement with the cavities 152, 154, 156, and 158 of the sidewalls 104 and 106. For instance, the projections may be constructed so that they can snap into the cavities to secure the exterior panels 204 to the sidewalls 104 and/or 106.

In some embodiments, the exterior panels 204 are constructed with different finishes and/or appearance according to the application and/or need. In various embodiments, the exterior panels 204 have a matte-marble finish. However, this is not necessarily limiting as the finish of the exterior panels 204 may vary in different embodiments. For example, in other embodiments the exterior panels 204 comprise matte, gloss, and/or satin finishes. In one or more embodiments, the exterior panels manufactured in any intended and/or available color.

In one or more embodiments, the lighting mounting system 200 further comprises a fastener 242 insertable through the aperture 160 of the securing member 100 and the aperture 208 of the rail 202. In various embodiments, the fastener 242 is a threaded bolt. The fastener is constructed to prevent or otherwise reduce the likelihood that the securing member 100 moves laterally along the length of the rail 202. However, the fastener is an optional feature as in other embodiments the securing member 100 is self-secured to the rail 202 without one. In various embodiments, the lighting mounting system 200 may be mounted directly on a surface, e.g., a wall or a ceiling, and/or to a component embedded or otherwise associated with the surface, to provide for a “surface-mounted” lighting mounting system 200 option.

In the non-limiting embodiment, as shown in FIG. 2C, the lighting mounting system 200 includes one rail 202 and a plurality of securing members 100. The plurality of the securing members 100 are attached to rail 202 along a length of the rail extending in a lateral direction. The plurality of securing members 100 are proximately parallel to each other. The lighting fixtures (shown in FIG. 2E) are attachable to the plurality of securing members 100 directly by pressing the lighting fixtures into the slot or lighting channel 130. In various embodiments, one lighting fixture is attached to two securing members 100A and 100B. It is appreciated that in some embodiments, one lighting fixture is attachable to one or more securing members 100A and/or 100B. In some embodiments, depending on the number of lighting channels, one securing member 100A and/or 100B is attachable to one or more lighting fixtures. FIG. 2D illustrates the lighting mounting system 200 with a power supply 236. The power supply 236 includes an electrical wire 238 and one or more ports 240. The electrical wire is constructed to be received by the slot 210 of the rail 202 and secured to the rail 202 by the or more securing members 100. Further to the foregoing example, in some embodiments the electrical wire 238 is between the slot 210 of the rail 202 and the base 102 of the securing members 100. The confined space between the rail slot 210 and the base 102 prevents or otherwise reduces excessive, unintended or undesirable vertical movements. The power supply 236 further has one or more ports 240. The one or more ports 240 is constructed to be mate with an inlet on a lighting fixture and provide electrical power to the lighting fixture. In the non-limiting example, one port 240 is installed on the electrical wire and is between the two securing members 100A and 100B. It is appreciated that the placement and number of the port may vary in different embodiments.

In one or more embodiments, the lighting mounting system 200 operates under Class 2 Low-voltage environment. In some embodiments, the lighting mounting system 200 does not require a conduit or a J-box except one or more circuits for plug-in and/or hard-wired main power supply. For example, the remaining cables between each lighting fixture mounted to the system 200 are jumper cables designed for low voltage applications.

In various embodiments, for example, as shown in FIG. 2E, the securing members 100 are constructed to receive lighting fixtures, such as LED strips. It is appreciated that the shapes and constructions of the lighting fixtures may vary in different embodiments. For example, in some embodiments, the securing member 100 may be constructed to receive various types of lighting fixtures. In various embodiments, the securing members 100 of the mounting system 200 may constructed to receive non-lighting fixtures such as artwork, structural elements, and curtains. As shown in FIG. 2E, the securing members 100A and 100B are spaced from each other at a length approximately equal to the length of a lighting fixture, for example, an LED strip. Once the inlet of the lighting fixture is mated with the port 240, e.g., a power input, of the power supply 236, e.g., a power cable, in some embodiments the port 240 of the power supply 236 is at least partially concealed by the lighting fixtures, the securing member 100, and the rail 202. In some embodiments, the power 240 is mounted separately and/or is at least partially concealed by the lighting fixtures, the securing member 100, and the rail 202. As will be explained below, additional embodiments according to the present disclosure relate to a power enclosure assembly 500 which can provide power to a lighting fixture(s) and or lighting system, and which is attachable to various structures and/or associated components.

In various embodiments, when assembled, the lighting mounting system 200 is constructed to at least partially conceal the power supply 236, e.g., a power cable, including the electrical wire 238 and one or more port 240. As shown in FIG. 2D, the electrical wire 238 is nested between the rail slot 210 and the base 102 of the securing member 100. After the securing member 100 and the rail 202 are mated to one another, an additional fastener may be provided to pass through the aperture 150 of the securing member 100 and one of the plurality of apertures 208 (as shown in FIG. 2A) to engage a fastener receiver. For example, the fastener and the fastener receiver may be respectively a bolt and a nut. In various embodiments, the noses 144 and 146 are comprise a flexible material and are spaced from each other with a distance approximately equal to the width of the electrical wire 238 to prevent lateral movements of the electrical wire 238. Upon securing the securing member 100 to the rail 202 with the fastener, the base 102 of the securing member 100 and the top 206 (as shown in FIG. 2A) of the rail 202 limit vertical movements of the electrical wire 238. As shown in FIG. 2E, when assembled, the slot base 210 of the rail 202, the sidewalls 214 and 216 of the rail 202, and the lighting strip form an approximately rectangular prism with a hollow interior that may be used to conceal an electrical wire(s) 238 therein.

In one or more embodiments, the lighting mounting system 200 comprises a cable management system to organize, distribute or reduce the space that would otherwise be required to house cables, wires and/or conduits for power supply and/or distribution. In at least one embodiment, the cable management system comprises a channel cover(s) or a clip(s) attachable to a component of the lighting mounting system 200 and/or the securing member 100.

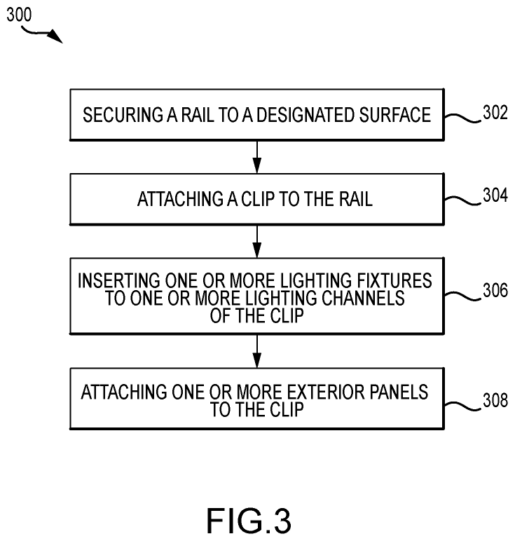

FIG. 3 is a flow diagram of a method 300 illustrating the lighting fixture installation method applying the lighting mounting system in accordance with one or more embodiments of the present disclosure. While a general order for the actions of the method 300 is shown in FIG. 3, the method 300 can include more or fewer actions. In addition, the order or the actions shown in FIG. 3 is not necessarily limiting as the order of the actions may be arranged differently (including simultaneously, substantially simultaneously, or sequentially) than those shown in FIG. 3. It is noted that the method 300 will be explained with reference to the components, devices, subassemblies, environments, etc. described in conjunction with FIGS. 1-2. For example, the embodiments as illustrated in FIGS. 1-2 should be understood as reading on the embodiments described with respect to FIG. 3, and vice versa, without departing from the scope of the present disclosure.

In embodiments, the rail 202 is secured 302 to a designated surface. For example, the rail may be installed, temporarily or permanently, on a designated surface. In a non-limiting embodiment, rail 202 is secured to a ceiling through a combination of mountain brackets and screws. It is appreciated that in some embodiments, the rail 202 may also be attached to a designated surface without fasteners; for example, it may be installed with snap-in components and/or adhesive. In some embodiments, the designated surface can be at any angle from the ground. For example, the designated surface may be a ceiling or a sidewall of a building, and in some other instances, the designated surface may be a light pole. In yet other embodiments, the designated structure is a different component, including without limitation, a component of an HVAC system such as ducting and/or supporting brackets, a truss ceiling, a drop down ceiling, or more generally to a structure outside of a building, for example, the underside of a bridge, the exterior façade of a building, etc.

In embodiments, one or more securing members 100 are attached 304 to the rail 200. In the non-limiting embodiments, one or more securing members 100 are attached to the rail after the rail is secured to a designated surface. In some other embodiments, one or more securing members 100 may be assembled to the rail before the rail is installed on the designated surface. In the non-limiting embodiment, as shown in FIG. 2C-2D, one or more securing members are constructed to snap into the rail. Specifically, the first and second rail channels 148 and 150 are made with flexible material, such as plastics including Polycarbonate, Nylon, Polypropylene, ABS, or Thermoplastic Elastomers, and can expand slightly to allow the channels 148 and 150 to be wide enough to receive the first and second sidewalls 214 and 216 of the rail. Once the rail is within channels 148 and 150, the channels 148 and 150 normally return to their initial shape, tightening and securing the securing member 100B to the rail 202. In various embodiments, the step of attaching 304 the securing member to the rail is toolless. It is appreciated that, in some embodiments, the securing member may be attached to the rail by other attaching mechanisms. For example, the securing member may be attached to the rail through welding and/or adhesive.

Additionally, a power supply 236 may be attached to the rail and secured to the rail 202 by a securing member 100. See the detailed description about attaching the power supply 236 to the rail 202 in the description of FIGS. 2D-2E.

Optionally, one or more fasteners may be applied to further secure the securing member 100B, preventing the securing member from lateral movements along the length of the rail 202.

In embodiments, lighting fixtures are inserted 306 to the one or more securing members 100. In the non-limiting embodiment, the lighting fixture is an LED stripe that can be inserted and snapped into the slot 130 directly. It is appreciated that the receivable fixtures are not limited to a lighting fixture or a stripe-shaped fixture. In some other embodiments, the slot 130 may be constructed to receive a painting or a curtain.

Optionally, one or more exterior panels 204 may be attached 308 to the securing member, providing a polished and smooth finish to the lighting mounting system. In some embodiments, as shown in FIG. 2B, the exterior panels 204 are constructed with magnetic materials and attached to the sidewalls 104 and 106 of the securing member 100 directly. It is appreciated that in some embodiments, exterior panels may also be attached to securing members through other attaching mechanisms such as adhesive and fasteners.

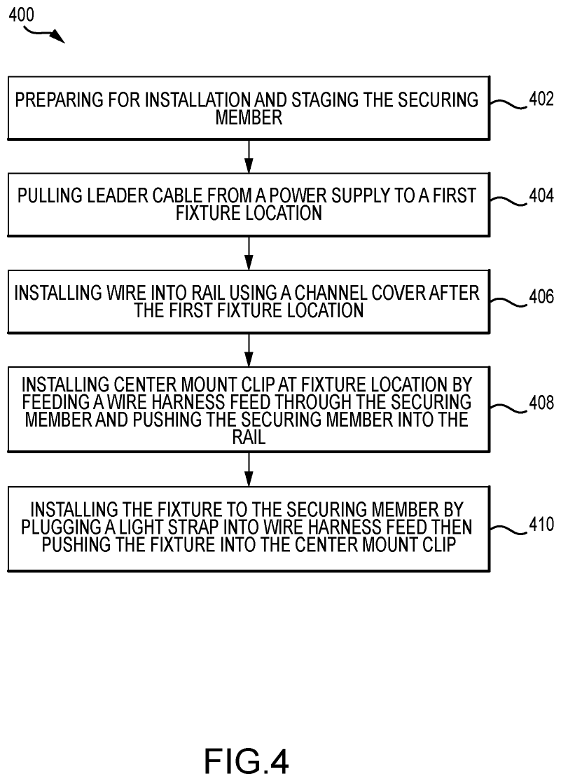

FIG. 4 provides a flow diagram of another method of mounting the lighting fixture to a designated surface utilizing the light mounting system. While a general order for the actions of the method 400 is shown in FIG. 4, the method 400 can include more or fewer actions or can arrange the order of the actions differently (including simultaneously, substantially simultaneously, or sequentially) than those shown in FIG. 4. It is noted that the method 400 shall be explained with reference to the components, devices, subassemblies, environments, etc. described in conjunction with FIGS. 1-2. For example, it is noted that the embodiments as illustrated in FIGS. 1-2 should be understood as reading on the embodiments described with respect to FIG. 4, and vice versa, without departing from the scope of the present disclosure.

In embodiments, the lighting mounting system 200 is unpacked and prepared 402 for the installation. In a non-limiting embodiment, to prepare the lighting mounting system 200 for the installation, a location is determined for the power supply 236. The locations of the lighting fixture are further determined and marked on the rail. For example, in some embodiments the locations of the lighting fixtures may be determined and marked in one or more groups of four, noting a first fixture location for connection to a leader cable. The light mounting system 200 is then unpacked and grouped together as they are to be installed. Optionally, in some embodiments a Fascia is used by connecting the mounting end clips (of the Fascia) to a lighting strip.

In some embodiments, the leader cable is pulled 404 from the power supply to the first fixture location, and wire is installed 406 into the rail. For example, in some embodiments the jumper cable may be installed into the rail by using a channel cover after the first fixture location. For example, in some embodiments the leader cable is plugged into one end of the wire harness, and the jumper cable is plugged into a second end of the wire harness.

A center mount clip is installed 408 at a designated fixture location by feeding the wire harness through the clip and then pushing the clip into the rail. The lighting fixture is then installed 410 to the securing member 100 by plugging the light strip into the wire harness and pushing the lighting fixture into the center mount clip.

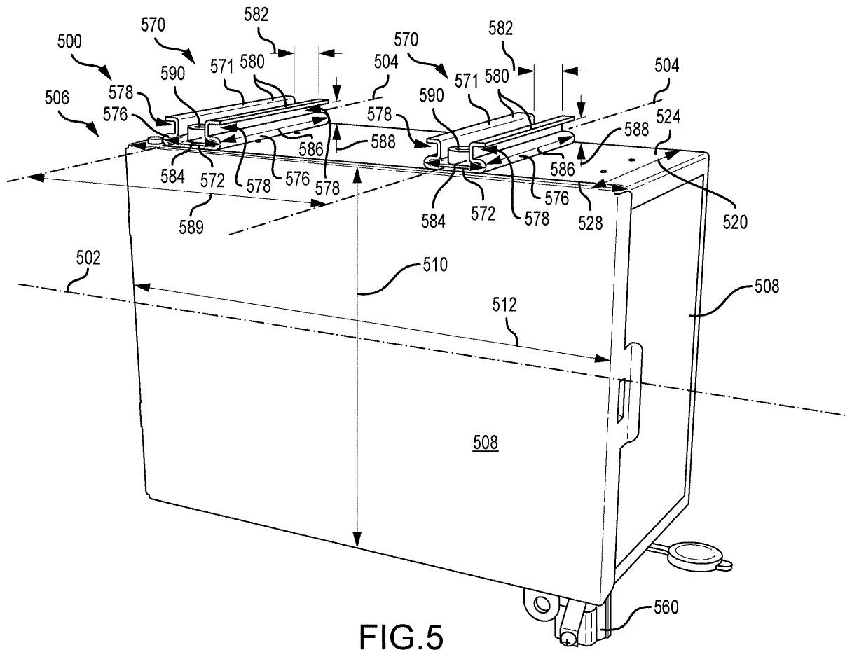

With reference to FIGS. 5-10, additional embodiments according to the present disclosure are directed to a power enclosure assembly 500 designed to facilitate its installation. That is, in various embodiment the power enclosure assembly 500 comprises various mounting components permit a single user to install the power enclosure assembly 500 onto a connecting member 670, e.g., a strut, that is connected, attached, embedded or otherwise associated with a building structure or element. As contemplated herein, the connecting member generally comprises a strut or a beam that is attached to a building structure or element. As contemplated by various embodiments, the building structure or element could be at least one of a ceiling, slab, window, cove enclosure, plenum, wall, enclosure, beam, column, frame, strut, girder, or another element of a building onto which the power enclosure assembly 500 may be mounted or otherwise secured, either directly or indirectly. In at least one alternative embodiment, the enclosure assembly 500 is attachable to a different component such as a component of an HVAC system, e.g., ducting and/or supporting brackets, a truss ceiling, a drop down ceiling, or more generally to a structure outside of a building, for example, the underside of a bridge, the exterior façade of a building, etc.

As such, in one or more embodiments, the mounting components of the power enclosure assembly 500 are configured to allow for a slide on installation into the connecting member 670. Thus, a single user may manually install or otherwise slidably connect the power enclosure assembly 500 with the connecting member 670, resulting in the power enclosure assembly 670 being interconnected to the building structure. In at least one embodiment, a single user may manually install the power enclosure assembly 500 into the connecting member 670 such that the power enclosure assembly is initially suspended in place. In such embodiments, once the power enclosure assembly 500 is suspended, the user's hands are no longer required to raise and/or hold the power enclosure assembly 500 and that same user may proceed to secure the power enclosure assembly 500 into the connecting member 670, e.g., by installing securing bolts and/or fasteners between to fixate the securing assembly to the connecting member. As will be explained hereinafter, the power enclosure assembly 500 is provided with securing members that allow suspended, upright and/or wall mounting securement.

As is shown at least in FIG. 5, in one or more embodiments, the power enclosure assembly 500 comprises a mounting assembly 570 with at least one mounting bracket 571 and an enclosure 506 with a plurality of panels that collectively define a closed shape of the enclosure 506. In various embodiments, the enclosure 506 comprises a group of side panels 508 that collectively define a quadrilateral shape. In various embodiments, a base panel 514 is connected or otherwise disposed adjacent to the side panels 508 around a distal end of the side panels 508. In one or more embodiments, a cover panel 524 is connected to or otherwise disposed adjacent the top panels 508 around a proximal end of the side panels 508.

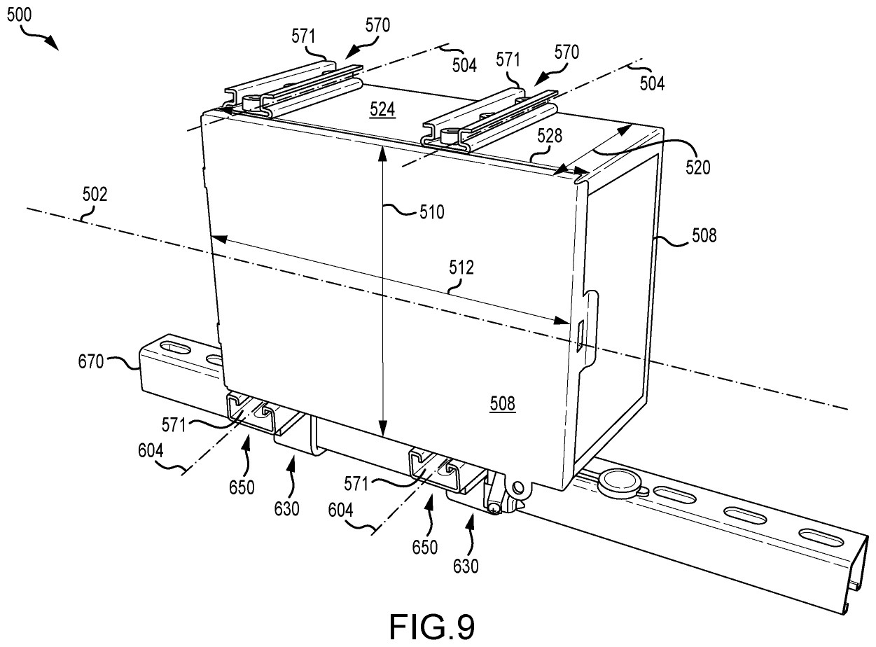

As shown in FIGS. 5-6 and 8-10, in some embodiments at least one mounting bracket 571 of the mounting assembly 570 is disposed on the top or cover panel 524. In such embodiments, the power enclosure assembly 500 may be mounted or otherwise secured in a suspended configuration. However, this is not necessarily limiting as in some embodiments, at least one mounting bracket 572 of the mounting assembly 570 is disposed on the base or bottom panel 524. In such embodiments, the power enclosure assembly 500 may be mounted or otherwise secured in an upright configuration. In at least one embodiment, for example as shown in FIG. 9, the mounting assembly 570 comprises at least one mounting bracket 571 disposed on the base panel 514 and at least one mounting bracket 571 disposed on the cover panel 524. In such embodiments, the power enclosure assembly 500 may be mounted or otherwise secured in either or both of a suspended or an upright configuration.

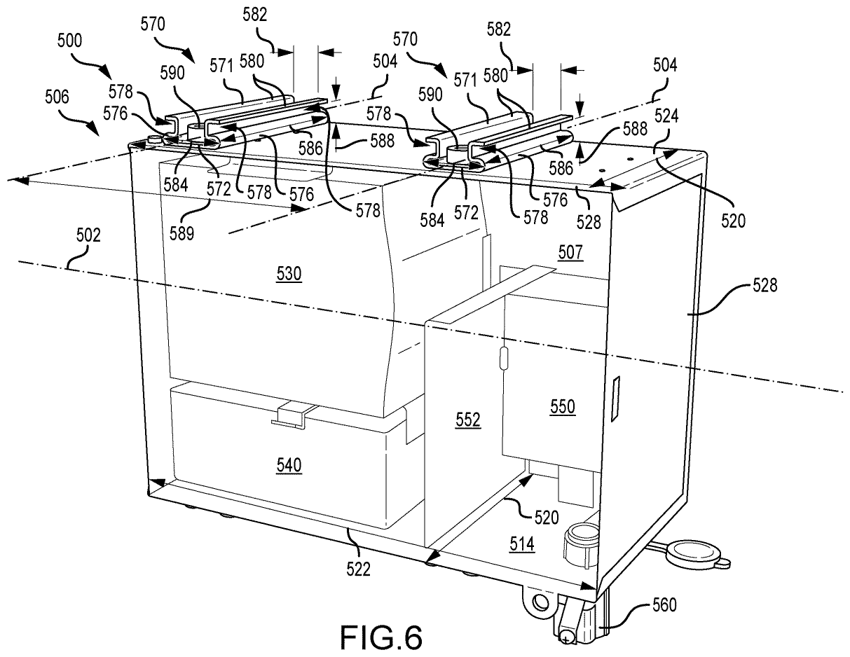

In various embodiments the mounting brackets 571 are connectable directly to a connecting member 670 and/or to a mounting cover 650 that may be used in connection with a securing member 630 to retain the connecting member 670. For example, as shown at least in FIGS. 5-6, in one or more embodiments a mounting bracket 571 comprises a base 572 with a width and a length that roughly define an overall width 584 and length 586 of the mounting bracket 571. In one or more embodiments, the mounting bracket(s) 571 comprises at least one side portion 576 adjacent to a top portion 580. In at least one embodiment, the side portion 576, the top portion 580 and/or the base 572 are constructed as a monolithic component during manufacturing. However, in other alternative embodiments, the side portion 576, the top portion 580 and/or the base 572 are formed as individual pieces and are joined together, for example, via welding or via one or more connectors or connecting components.

In various embodiments, the side portion 576 and the top portion 580 collectively define a cavity 578 for insertion of a connecting portion of a mounting cover 650 and/or a connecting member 670. For example, in one or more embodiments, the side portion 576 comprises an “L” shape, or a related shape. In such embodiments, the side portion 576, the top portion 580 and/or the base 572 collectively define an “S” shape of a side of the mounting bracket 571 with a cavity 578. In one or more embodiments, the mounting bracket(s) 571 comprises two side portions 576 oppositely disposed to one another on the sides of the base 572. In such embodiments, corresponding top portions 580 define two individual cavities 578 that face away from one another and that are collectively operable for insertion of corresponding connecting portions of a mounting cover 650 and/or a connecting member 670 to attach or otherwise connect the mounting bracket(s) 571 to the mounting cover 650 and/or to the connecting member 670. In various embodiments, a gap 582 is defined between the side portions 576. Such a gap 582 permits access to an exterior side of the base 572, which may have one or more openings to connect the mounting bracket(s) 571 to the base panel 514 and/or cover panel 524, for example, via a connector or fastener 590.

As shown in FIGS. 5-7 and 8-9, in one or more embodiments, the mounting bracket(s) 571 extend along an axis 504 that is substantially transverse to a longitudinal axis 502 of the enclosure 506. However, this is not necessarily limiting as in other embodiments, the mounting bracket(s) 571 extend along the longitudinal axis 502. In one or more embodiments (not shown) a mounting bracket(s) extends along the longitudinal axis 502 and is connected directly to the base panel 514 and/or the cover panel 524. In alternative embodiments, the mounting bracket(s) 571 and/or 573, which will be explained below, are disposed at an angle of inclination within a horizontal plane and relative to the longitudinal axis 502 and/or the transverse axis 504.

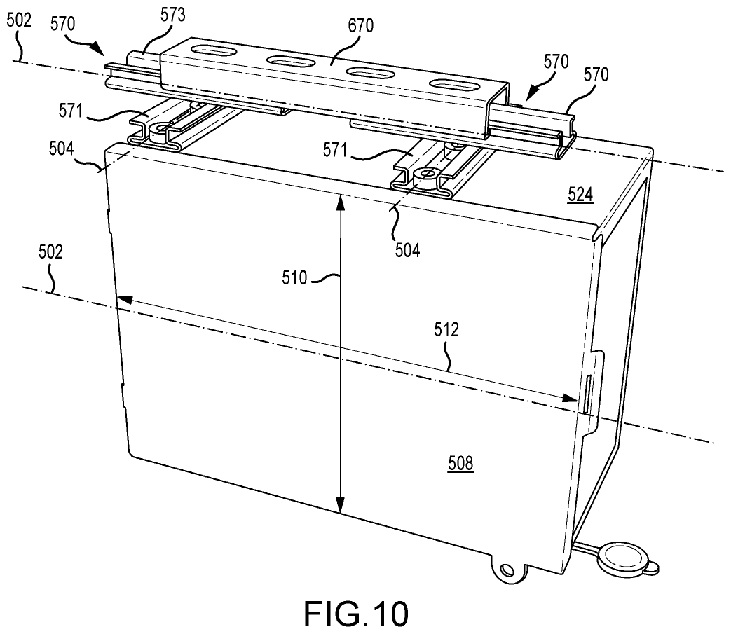

As shown in FIG. 10, other embodiments of the power enclosure assembly 500 contemplate providing a “stacked arrangement” of mounting brackets 571, 573. As contemplated by various embodiments of the power enclosure assembly 500, the brackets 571 and/or 573 are interchangeable and may be collectively arranged to attach to a common interface, i.e., connecting member 670 and/or mounting cover 650, according to specific applications, field conditions, building components, geometrical constraints, etc. That is, in one or more embodiments, additional or fewer mounting brackets 571 and/or 573 may be provided and attached to the enclosure as may be needed, reducing the need to make chassis modifications or otherwise significant modifications to the enclosure 506. In one or more embodiments, a first mounting bracket(s) 571 is connected or otherwise disposed onto the base panel 514 and/or the cover panel 524, and a second bracket(s) 573 is connected to the first mounting bracket(s) 571. As shown in FIG. 10, in one or more embodiments the first and second brackets 571 and 573 are connected to and transverse to one another. In such embodiments, the second bracket(s) 573 are also aligned along the longitudinal axis 502. As is also shown in FIG. 10, in some embodiments two groups of mounting brackets 571 and 573 are provided. In such embodiments, the second mounting brackets 573 are aligned with one another along the longitudinal axis 506 such that each one can retain a retaining portion(s) and/or side of a mounting cover 650 and/or connecting member 670, which also extend along the longitudinal axis 506. In some embodiments where two (or more) mounting brackets 571 are disposed directly on the base panel 514 or the cover panel 524, the mounting brackets 571 may be aligned with one another along the longitudinal axis 502 to a retaining portion(s) and/or side of a mounting cover 650 and/or connecting member 670. However, in other embodiments a similar alignment of the mounting brackets 573 and/or 571 is also possible along the transverse axis 504. In at least one alternative embodiment (not shown) a single second mounting bracket 573 extends along the longitudinal axis 506 and is connected to two different first mounting brackets 571.

As mentioned above, two (or more) mounting brackets 571 and/or 573 may be disposed on the base panel 514 and/or the cover panel 524 to connect the mounting brackets 571 and/or 573 to the mounting cover 650 and/or connecting member 670. As shown in FIGS. 5-6, in one or more embodiments the mounting brackets 571 (and/or 573) are spaced apart from one another an offset distance 589. Such an offset distance 589 may be advantageous to at least partially increase stability of the enclosure 506 relative to the connecting member 670. However, an offset distance 589 is not strictly required as in other embodiments two (or more) mounting brackets 571 and/or 573 are adjacently disposed to one another.

With reference to FIG. 6, in one or more embodiments according to the present disclosure, the power enclosure assembly 500 is operable to retain one or more of a power supply unit 530, a battery unit 540 and/or a control module 550, within an interior 507 thereof. As shown in FIG. 6, in one or more embodiments, the power enclosure assembly 500 contains an emergency power backup battery unit 540 and a battery charging power supply unit 530. In one or more embodiments, the power enclosure assembly 500, including via the power supply unit 530 and/or battery unit 540 is operable to power an operatively connected channel(s) of light fixtures, including at a capacity that is less than 100%, to achieve various levels of illumination. In at least one embodiment, the power supply unit 530 and/or battery unit 540 is operable to power five operatively connected channels of light fixtures at approximately 10% of their full output level, to achieve at least one footcandle of illumination at floor level for at least 90 minutes, including along an egress path for at least ninety minutes during a power failure as is required by NFPA 101 emergency lighting standards. As contemplated by various embodiments, the various units, e.g., 530, 540 and/or 550, are separated within the enclosure 506 by separation components, e.g., indicated at 522. In some embodiments, the various units, e.g., 530, 540 and/or 550, are modular slide-in components or otherwise as distinct units that may be inserted into different spaced within the interior of the enclosure.

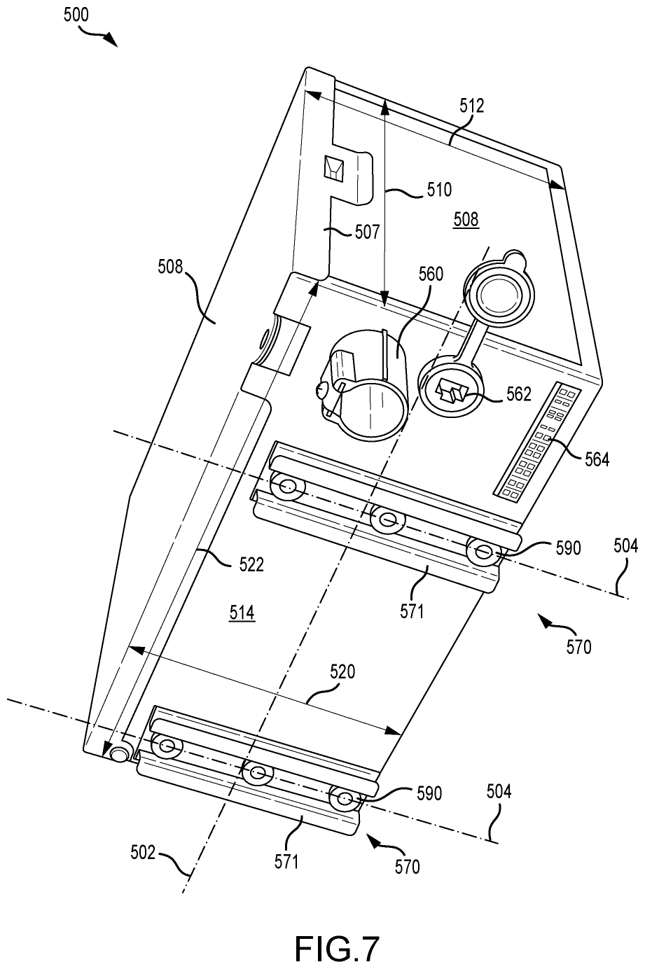

With reference to at least FIG. 7, in one or more embodiments, various ports and/or outputs are disposed on the base panel 514 and/or cover panel 524 of the enclosure 506. For example, as shown in FIG. 7, in some embodiments a power port(s) 560, a data port(s) 562 and/or a low voltage port(s) 564 are disposed on the base panel 514 and are operably connected to interior power and/or data components of the power enclosure assembly 500, including the power supply unit 530, battery unit 540 and/or control module 550. In various embodiments, the power enclosure assembly 500 comprises hard wired universal power input 560 that is about 90 volt alternating current (VAC) to about 305 VAC, including a power port 560 comprising a three-phase 277 VAC. In one or more embodiments, the power enclosure assembly 500 comprises a power port 560 comprising five 48 volt direct current (VDC) output channels with plug and play ports. In some embodiments, the power enclosure assembly 500 comprises two non-emergency power supplies in parallel with ten output channels with plug and play ports. However, the foregoing embodiments are non-limiting as in other embodiments the power enclosure assembly 500 is provided with other configurations of a power port(s) 560, a data port(s) 562 and/or a low voltage port(s) 564.

As contemplated by various embodiments of the power enclosure assembly 500, various mounting components may be slidably connected to one another to facilitate installation of the power enclosure assembly 500 in the field. In one or more embodiments, the mounting brackets 571, including the cavity 578, are configured and dimensioned for slidable insertion of a corresponding connecting portion of a mounting cover 650 and/or a connecting member 670 connect the mounting bracket(s) 571 to the mounting cover 650 and/or to the connecting member 670. For example, with reference to FIG. 10, during field installation, a user may manually place a mounting bracket(s) 573 within a connecting member 670 that is already attached or connected to a building structure or component. Once an initial engagement of the connecting portion of the mounting cover 650 and/or a connecting member 670 has been established, a user may slide the mounting bracket(s) 573 into the connecting member 670 into an intended position where the mounting bracket(s) 573 and/or 571 may be secured, e.g., via connectors or fasteners, relative to the connecting member 670. In at least one embodiment, the power enclosure assembly 500 will be suspended such that the user will have his/her hands free to secure the mounting bracket(s) 573 and/or 571 relative to the connecting member 670.

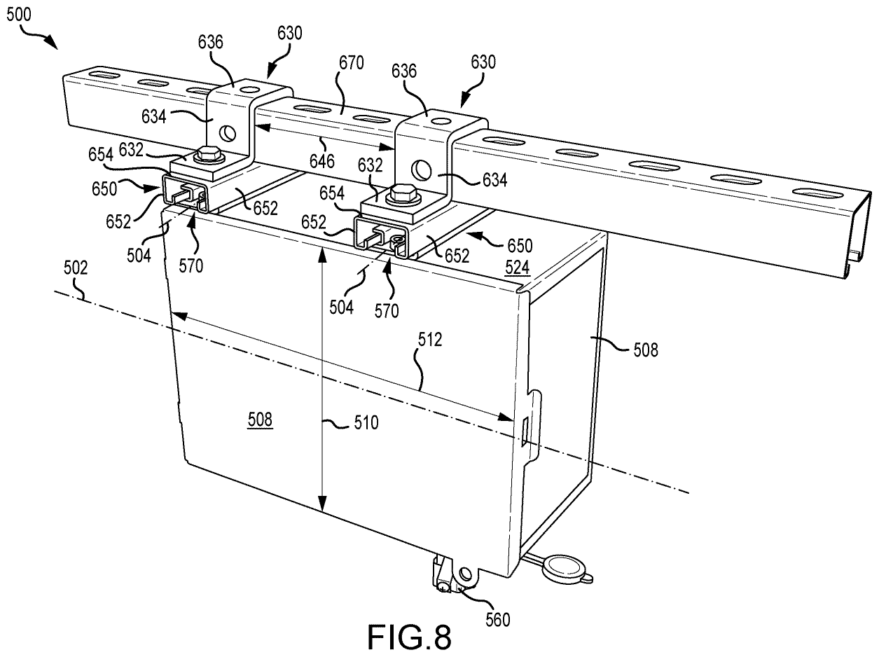

As a further example, and as shown in FIGS. 8-9, in other embodiments, a securing member(s) 630 and a mounting cover(s) 650 are used to retain a connecting member 670 (already installed or associated with a building component or structure) prior to a slidable insertion of a mounting bracket 571 into a corresponding mounting cover 650. For example, FIG. 8 shows an illustrative embodiment of a “strut” top mount configuration of the power enclosure assembly 500. In the embodiment shown in FIG. 8, a securing member(s) 630 is placed over the connecting member 670, and a mounting cover(s) 650 is placed below the connecting member 670, such that the base portions 632 are adjacent to the mounting cover(s) 650 such that a fastener or connector may be used to secure the base portions 632 to the mounting cover(s) 650 thereby securing the connecting member 670 within securing member(s) 630 and the mounting cover(s) 650. In the embodiment shown in FIG. 9, a similar installation may be achieved from below the connecting member 670 to secure it to the securing member(s) 630 and the mounting cover(s) 650. In the embodiment shown in FIG. 8, a mounting bracket(s) 571 of an enclosure assembly 500 on the cover panel 524, is slidably insertable into an already installed mounting cover(s) 650 such that the power enclosure assembly 500 is in a suspended position. As a further example, FIG. 9 shows an illustrative embodiment of a “strut” bottom mount configuration of the power enclosure assembly 500. In the embodiment of FIG. 9, a mounting bracket(s) 571 of an enclosure assembly 500 on the base panel 514, is slidably insertable into an already installed mounting cover(s) 650 such that the power enclosure assembly 500 is in an upright position. Once the power enclosure assembly is in an intended position, fasteners or connectors may be used to secure the mounting bracket(s) 571 to the mounting cover(s) 650. However the embodiments shown in FIGS. 8-9 are only illustrative and are not exhaustive of all possible mounting arrangements of the power enclosure assembly 500.

Additional embodiments according to the present disclosure are directed to a method for installing a power enclosure assembly onto a building structure. In one or more embodiments, the method initially comprises providing a power enclosure assembly 500 for a lighting system as described herein. That is, in one more embodiments of the method, the power enclosure assembly 500 comprises: an enclosure 506 operable to enclose at least one of a power unit 530, a battery unit 540 and/or a control module 550. In one or more embodiments of the method, the enclosure 506 comprises a plurality of panels collectively defining a closed shape of the enclosure 500. In at least one embodiment of the method, the plurality of panels comprises a group of side panels 508, a base panel 514 and a cover panel 524. In one or more embodiments of the method, the power enclosure assembly 500 comprises a mounting assembly 570 comprising a mounting bracket(s) 571 and/or 573 on the cover panel 524 or on the base panel 514. In one or more embodiments, the mounting bracket(s) 571 and/or 573 is slidably attachable by a single user to a connecting member 670 that is associated with, i.e., connected or attached to, the building structure.

In various embodiments, the method further comprises inserting the mounting bracket(s) 571 and/or 573 onto a connecting member 670 directly, or to a mounting cover 650 that is attached or connected to the connecting member 670, including to achieve a “hands-free” suspension of the enclosure 506. Such embodiments contemplate that once the bracket(s) 571 and/or 573 are inserted and retained within the mounting cover 650 and/or connecting member 670, the user no longer needs to manually support, lift or otherwise hold the assembly such that both of the user's hands are free to secure the bracket(s) 517 and/or 573 to the mounting cover 650 and/or connecting member 670. In one or more embodiments, the method further comprises positioning the mounting bracket(s) 571 and/or 573 such that the enclosure 506 is at an intended position within the connecting member or the mounting cover. In various embodiments, the method further comprises securing the at least one mounting bracket(s) 571 and/or 573 to the connecting member 670 and/or the mounting cover 650, for example, via one or more connectors, e.g., bolts, screws, fasteners, clips, etc.

The foregoing discussion has been presented for purposes of illustration and description. The foregoing is not intended to limit the disclosure to the form or forms disclosed herein. In the foregoing Detailed Description, for example, various features are grouped together in one or more embodiments for the purpose of streamlining the disclosure. The features of the embodiments may be combined in alternate embodiments other than those discussed above. This method of disclosure is not to be interpreted as reflecting an intention that the claims require more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate embodiment.

The devices, methods, and systems of the disclosure are further described and exemplified in the attached Appendix A. In particular, Appendix A includes drawings and other images of various embodiments of the securing members and lighting mounting systems. It is noted that any line in the exemplary additional views of the securing member and/or the lighting mounting system may be illustrated as solid or broken lines, including any section or length of each individual line, without departing from the scope of the present disclosure.

Moreover, though the present disclosure has included description of one or more embodiments and certain variations and modifications, other variations, combinations, and modifications are within the scope of the disclosure, e.g., as may be within the skill and knowledge of those in the art, after understanding the present disclosure. It is intended to obtain rights which include alternative embodiments to the extent permitted, including alternate, interchangeable, and/or equivalent structures, functions, ranges, or steps to those claimed, regardless of whether such alternate, interchangeable, and/or equivalent structures, functions, ranges, or steps are disclosed herein, and without intending to publicly dedicate any patentable subject matter.

What is claimed is:

1. A securing member for securing lighting fixtures, the securing member comprising:
a base comprising an upper surface and a lower surface:
a first sidewall extending in a vertical direction over the upper surface and the lower surface of the base, the first sidewall comprising an interior surface and an exterior surface; and
a second sidewall extending in the vertical direction over the upper surface and the lower surface of the base, the second sidewall being parallel to the first sidewall in a longitudinal direction, wherein the second sidewall comprises an interior surface and an exterior surface;
the lower surface of the base and the interior surfaces of the first and second sidewalls collectively defining a slot operable to receive the lighting fixtures; and
a recess operable to secure the securing member to a designated surface and to receive one or more wires, wherein the recess is defined by the upper surface of the base and the interior surfaces of the first and second sidewalls.

2. The securing member of claim 1, wherein the first sidewall has a first section and a second section, wherein the second section is located between the first section of the first sidewall and the base, wherein the second section comprises a first rail channel.

3. The securing member of claim 1, wherein the second sidewall has a first section and a second section, wherein the second section is located between the first section of the second sidewall and the base, wherein the second section comprises a second rail channel.

4. The securing member of claim 1, wherein the one or more wires comprise a lead wire.

5. The securing member of claim 1, wherein base further comprise a first projection extending from the upper surface in the vertical direction and a second projection parallel to the first projection in the longitudinal direction, wherein the first and second projections collectively define a channel of the base, and wherein the channel is operable to secure the wire within the securing member.

6. The securing member of claim 1, wherein the designated surface is a rail.

7. The securing member of claim 1, wherein the securing member is comprises magnetic materials.

8. A lighting mounting system, comprising:
a rail; and
a securing member comprising:
a base comprising an upper surface and a lower surface:
a first sidewall extending in a vertical direction over the upper surface and the lower surface of the base, the first sidewall comprising an interior surface and an exterior surface; and
a second sidewall extending in the vertical direction over the upper surface and the lower surface of the base, the second sidewall being parallel to the first sidewall in a longitudinal direction, wherein the second sidewall comprises an interior surface and an exterior surface;
a slot operable to receive a lighting fixture and being defined by the lower surface of the base and the interior surfaces of the first and second sidewalls; and
a recess defined by the upper surface of the base and the interior surfaces of the first and second sidewalls,
wherein the recess is operable to receive the rail and attaching the securing member to the rail.

9. The lighting mounting system of claim 8, further comprising a power supply attached to the rail and secured by the securing member.

10. The lighting mounting system of claim 9, wherein the power supply comprises an electrical wire and one or more ports, and wherein the electrical wire passes through the slot of the rail.

11. The lighting mounting system of claim 8, wherein base further comprise a first projection extending from the upper surface in the vertical direction and a second projection parallel to the first projection in the longitudinal direction, wherein the first and second projections define a channel of the base, wherein the channel is operable to secure the wire within the securing member.

12. The lighting system of claim 8, wherein the securing member comprises magnetic materials, and wherein the securing member is attachable the rail without using tools.

13. The lighting system of claim 8, wherein the securing member is attachable to the rail through adhesive.

14. The lighting system of claim 8, wherein the slot is a lighting channel operable to receive a lighting fixture.

15. The lighting system of claim 8, wherein the slot is constructed to receive at least one of a power sensor, a display, a screen, and electronic devices comprising a jumper cable or a modular connector.

16. A method of installing a lighting fixture, comprising:
securing a rail to a designated surface;
attaching one or more securing members to the rail, each of the one or more securing members comprising a lighting channel;
inserting the lighting fixtures to the lighting channel of the one or more securing members; and
attaching an exterior panel to the securing member.

17. The method of claim 16, further comprising:
staging the securing member for installation;
pulling a lead cable from a power supply to a first fixture location;
installing a jumper cable into a channel of the rail;
installing a center mount clip; and
plugging the lighting fixture into the center mount clip.

18. The method of claim 17, wherein the staging the securing member comprises:
determining a location for the power supply;
determining and marking fixture locations on the rail into groups; and
unpacking the securing member and aligning the securing member to the rail for installation.

19. The method of claim 18, wherein each of the groups comprises four fixture locations.

20. The method of claim 17, wherein the center mount clip comprises a wire harness feed operable to receive the lighting fixture.
